(19) United States
(12) Patent Application Publication
(10) Pub. No.: US 2009/0124124 A1
(43) Pub. Date: May 14, 2009

(54) Electrical connector with shell interferentially engaged with portion of the connector

(75) Inventors: Lin Huang, ShenZhen (CN); Yu-San Hsiao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/287,931

(22) Filed: Oct. 14, 2008

(30) Foreign Application Priority Data
Oct. 12, 2007 (CN) 200720043641.0

(51) Int. Cl. H01R 13/648

(52) U.S. Cl. 439/607.02

(57) ABSTRACT

An electrical connector (1) is adapted for mounting to a circuit substrate having a metallic shell (2) assembled onto an insulated housing (3). The metallic shell (2) has a base portion with two side-walls (23) and a pair of arms (24) extending from the side-walls (23). Some interferential tabs (243) are introverted on both of the arms (24) and corresponding slots (311) are formed on the insulated housing (3). When assembling, the interferential tabs (243) are engaged with corresponding slots (311) to firmly fit the metallic shell (2) and insulated housing (3) together.

### BACKGROUND OF THE INVENTION

1. Field of the Invention

The present invention relates to an electrical connector, and more particularly, to an electrical connector with a metallic shell interferentially engaged with a portion of the connector.

2. Description of Related Art

The SFF Committee is an ad hoc group formed to address storage industry needs in a prompt manner. One kind of connector named Mini SAS connector adapted for high-speed transmission has been defined by the SFF Committee. Several types of utility Mini SAS connectors have been launched and U.S. Pub. No. 2006/0160399 A1 discloses such kind of connector. The connector includes a connector guide made of metallic sheet and located in front of an insulated housing. The connector guide and the insulated housing are separately mounted on a circuit substrate. When mounting onto the printed circuit board, the relative position between the connector guide and the insulated housing is loosely controlled, and the assemble process is heavy and complicated.

U.S. Pat. No. 7,331,822 B2 issued to Amphenol on Feb. 19, 2008 discloses another receptacle for a pluggable module including a conductive housing having two side walls and a metallic shell assembled onto the conductive housing with a barb 24 and a engaging portion 15. In this way, the conductive housing and the metallic shell can join together. However, the fixation of elastic lock may affect the stability of new combination and it is still hard to fix the conductive housing and the metallic shell firmly.

Hence, an improved electrical connector with a firm fixed metallic shell is highly desired to overcome the disadvantages of the related arts.

### SUMMARY OF THE INVENTION

Accordingly, the object of the present invention is to provide an electrical connector with improved structure to make it firm and convenient to assemble a metallic shell to an insulated housing.

In order to achieve the object set forth, an electrical connector in accordance with the present invention is adapted for mounting to a circuit substrate having a metallic shell assembled onto an insulated housing. The metallic shell has a base portion with two side-walls and a pair of arms extending from the side-walls. Some interferential tabs are introverted on both of the arms and corresponding slots are formed on the insulated housing. When assembling, the interferential tabs are engaged with corresponding slots to firmly fit the metallic shell and insulated housing together.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the electrical connector of an embodiment of the present invention;

FIG. 2 is an exploded, perspective view of the electrical connector as shown in FIG. 1;

FIG. 3 is a perspective view of the metallic shell as shown in FIG. 2;

FIG. 4 is an enlarged, perspective view of the interference tab as shown in FIG. 3;

FIG. 5 is a perspective view of the insulated housing as shown in FIG. 2;

### DETAILED DESCRIPTION OF THE INVENTION

Reference will now be made in detail to the preferred embodiment of the present invention.

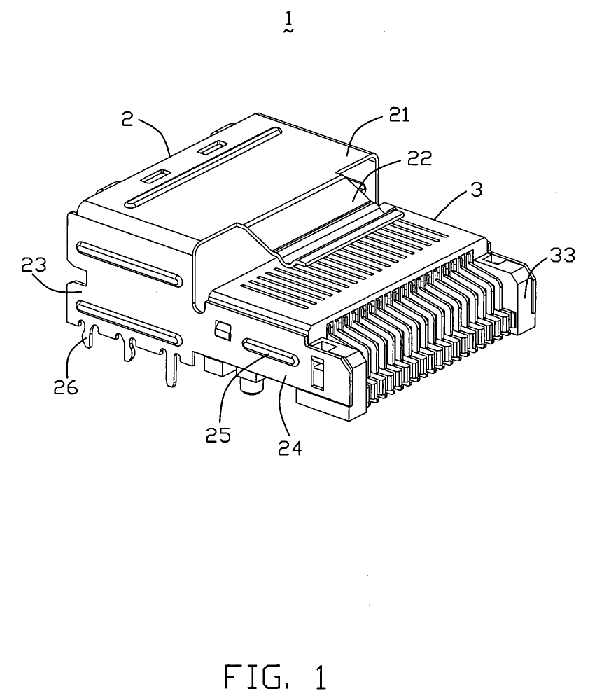

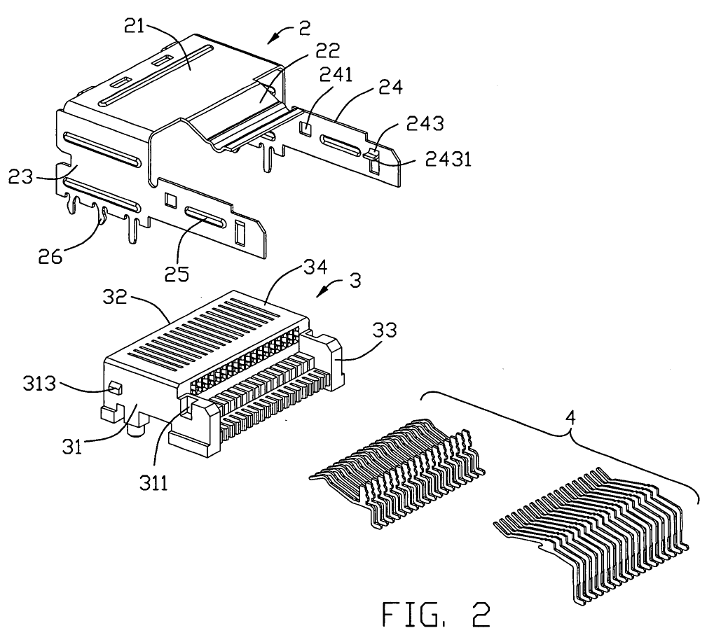

Referring to FIGS. 1-2, an electrical connector 1 for mounting on a circuit substrate (not shown) in accordance with the embodiment of the present invention comprises an insulated housing 3, a plurality of terminals 4 received in the insulated housing 3, and a metallic shell 2 assembled onto the insulated housing 3.

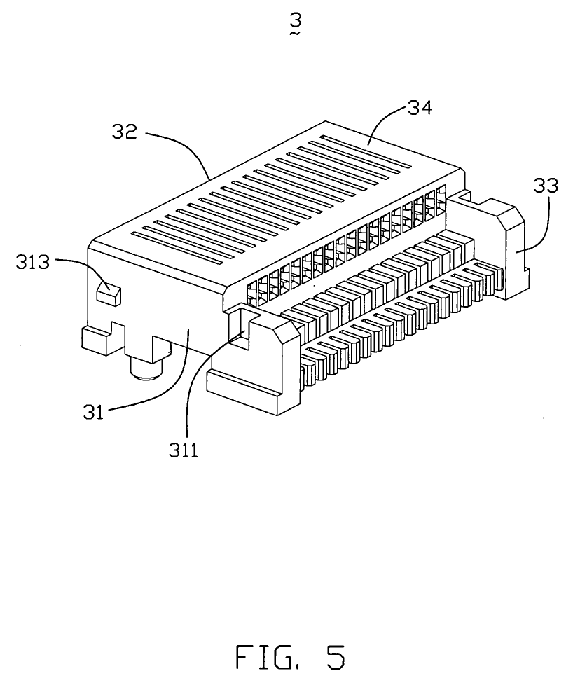

Referring to FIG. 5, the insulated housing 3 comprises a mating face 32, a rear face 33, a top face 34 and a pair of side-faces 31 interconnecting with the mating face 32, the rear face 33 and the top face 34. Vertical slots 311 and projections 313 are formed on the both side-faces 31 symmetrically to lock with said metallic shell 2. Said vertical slots 311 are hollowed from the top-face 34 and opening with the side-faces 31.

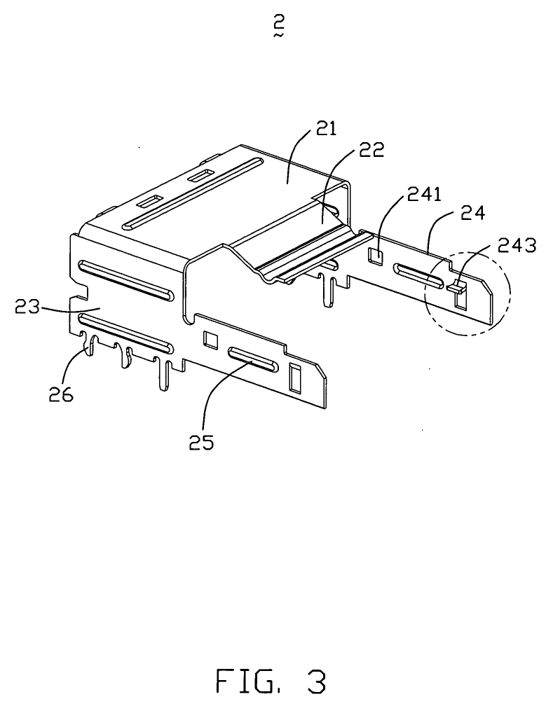

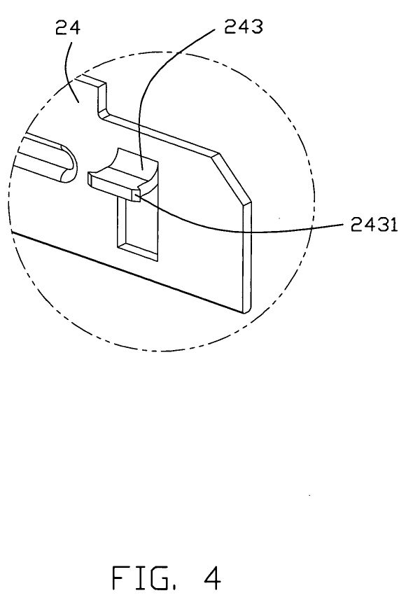

Referring to FIGS. 2-4, The metallic shell 2 having a base portion defining a first receiving space therein, and a pair of arms 24 extending from the base portion and defining a second receiving space therebeween. Said insulated housing was assembled in the second receiving space, and said first receiving space is surrounded by a top-wall 21, a pair of side-walls 23 linked by the top-wall 21. A spring member 22 firstly extending rearward and downwardly from middle part of rear edge of the top-wall 21, then extending rearward and upwardly to form a lowest pressing portion that face to face with the top-face 34 of the insulated housing 3. Introverted interference tabs 243 were defined on the free end of said arms 24, and the end 2431 of the interference tabs 243 are a little wider than corresponding vertical slots 311 so as to make interference.

Referring to FIGS. 1-5, when assembly, the insulated housing 3 is in the second receiving space between two side-walls 23, and said first receiving space defines a guiding space for opposing connector. The through hole 241 of the metallic shell 2 locked with the projection 313 of the insulated housing 3 elastically, and the interference tabs 243 of the metallic shell 2 inserted into corresponding vertical slots 311 of the insulated housing 3 to make a firm fix. Protruding bar 25 is formed between the through hole 241 and the interference tab 243 to strengthen the side-walls 23, and elastic board locks 26 are formed on the second receiving space to assemble onto the circuit substrate easily.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
a metallic shell having a base portion defining a first receiving space therein, and a pair of arms extending from the base portion and defining a second receiving space therebeween;
a insulated housing assembled in the second receiving space;
a plurality of terminals received in said insulated housing; and
interferential arrangement between the metallic shell and the insulated housing, and including a tab extending from the arm and a slot defined in the insulated housing and in which the tab interferential engaged with the slot.

2. The electrical connector as claimed in claim 1, wherein said interference tab is introverted from said arms.

3. The electrical connector as claimed in claim 2, wherein said insulated housing defines a side-face, said slot is a vertical slot hollowed from the top-face and opening with the side-face.

4. The electrical connector as claimed in claim 3, wherein said interference tab is on the free end of said arm.

5. The electrical connector as claimed in claim 4, wherein each of said arms near the base portion defines a through hole and a projection defined on said side-face to lock with said through hole.

6. The electrical connector as claimed in claim 5, wherein a protruding bar is formed between the interference tab and the through hole.

7. The electrical connector as claimed in claim 5, wherein and a elastic board lock is formed on the first receiving space.

8. An electrical connector adapted for mounting to a circuit substrate, comprising:
an insulated housing comprising a top-face and a pair of side-faces, vertical slots defined on said side-faces;
a plurality of terminals received in said insulated housing;
a metal shell assembled onto said insulated housing, comprising a top-wall, a pair of side-walls linked by the top-wall and a pair of arms extending rearward from said side-walls, interference tab introverted from each of said arms, and vertical slot formed on the insulated housing to hold the tab.

9. The electrical connector as claimed in claim 8, wherein said vertical slot is hollowed from the top-face and opening with corresponding side-face.

10. The electrical connector as claimed in claim 9, wherein said interference tab is on the free end of the arm.

11. The electrical connector as claimed in claim 10, wherein said top-wall and two side-walls defining a base portion, each of said arms near the base portion defines a through hole and a projection defined on said side-face to lock with said through hole.

12. The electrical connector as claimed in claim 11, wherein a protruding bar is formed between the interference tab and the through hole.

13. An electrical connector comprising:
an insulative housing defining a mating port exposed to an exterior through a front mating face, and two side faces rearwardly extending from two opposite sides of the front mating face;
a metallic shell assembled to the housing and including an upside down U-shaped main body including a top wall and two side walls and located in front of the front mating face of the housing under a condition that said top wall of said main body is higher than the housing;
a spring member unitarily extending rearwardly from a rear edge of the top wall toward the housing; and
a pair of extension arms unitarily extending rearwardly from rear edges of said two opposite side walls of the main body; wherein
fastening means is formed on the extension arm and the corresponding side face for fastening the extension arm and the corresponding side face together under a condition that said fastening means is configured to only allow assembling between the shell and the housing in a vertical direction.
